(19) United States
(12) Patent Application Publication
(10) Pub. No.: US 2006/0083022 A1
(43) Pub. Date: Apr. 20, 2006

(54) Backlight unit for liquid crystal display

(75) Inventors: Francis Chung Hwa Pan, Taichung City (TW); John Chungteh Pan, Taichung City (TW); Tsung-Neng Liao, Taichung County (TW)

Correspondence Address: BIRCH STEWART KOLASCH & BIRCH, PO BOX 747, FALLS CHURCH, VA, 22040-0747, US

(73) Assignee: FORHOUSE CORPORATION

(21) Appl. No.: 10/965,961

(22) Filed: Oct. 18, 2004

(51) Int. Cl. F21V 7/04

(52) U.S. Cl. 362/600

(57) ABSTRACT

A backlight unit has a light guide plate with a diffusive layer therein. The light guide plate has a first side, a second side opposite to the first side and a third side. The diffusive layer has a base and a plurality of grains in the base. A lamp is arranged beside the third side of the light plate to provide light to the light guide plate. A reflective film is attached on the second side of the light guide plate to reflect light. A brightness enhance member is provided at the first side of the light guide plate.

### BACKGROUND OF THE INVENTION

1. Field of the Invention

The present invention relates generally to a liquid crystal display, and more particularly to a backlight unit for the liquid crystal display, which has a well performance in diffusion and light guide.

2. Description of the Related Art

FIG. 4 shows a conventional edge-light backlight unit 60, which has a light guide plate 62, a lamp 64 arranged at a lateral side of the light guide plate 62, a reflective film 66 attached on a bottom side of the light guide plate 62, a diffusive film 68 attached on a top side of the light guide plate 62 and two prism plates 70 and 72 arranged above the diffusive film 68.

The lamp 64 provides light to the light guide plate 62 and the reflective film 66 reflects the light to emit the light to the top side of the light guide plate 62 and pass through the diffusive film 68. As shown in FIG. 5, the diffusive film 68 has a plurality of grains 681 to reflect and refract light for diffusion.

Another conventional backlight unit provides a light guide plate, in which reflecting grains are distributed uniformly to replace the diffusive film. The grains are very expensive that increases the cost of the light guide plate. In the process of fabrication of Su's light guide plate, the grains are reacted with the light guide plate in the high temperature environment that makes the light guide plate yellowing. The yellowing of the light guide plate changes the chroma.

### SUMMARY OF THE INVENTION

The primary objective of the present invention is to provide a backlight unit, which has a well performance in diffusion.

The secondary objective of the present invention is to provide a backlight unit, which the light guide plate is thinner than the conventional device.

According to the objectives of the present invention, a backlight unit comprises a light guide plate having a diffusive layer therein. The light guide plate has a first side and a second side opposite to the first side. The diffusive layer has a base and a plurality of grains in the base and is arranged between the first side and the second side of the light guide plate. A lamp is arranged beside the light plate. A reflective film is attached on the second side of the light guide plate. A brightness enhance member is provided at the first side of the light guide plate.

### BRIEF DESCRIPTION OF THE DRAWINGS

FIG. 1 is an exploded view of a first preferred embodiment of the present invention;

FIG. 2 is a sectional view of the light guide plate of the first preferred embodiment of the present invention, showing the path of light;

FIG. 3 is an enlarged view of a second preferred embodiment of the present invention;

FIG. 4 is an exploded view of the conventional backlight unit, and FIG. 5 is an enlarged of the light guide plate of the conventional backlight unit, showing the path of light.

### DETAILED DESCRIPTION OF THE INVENTION

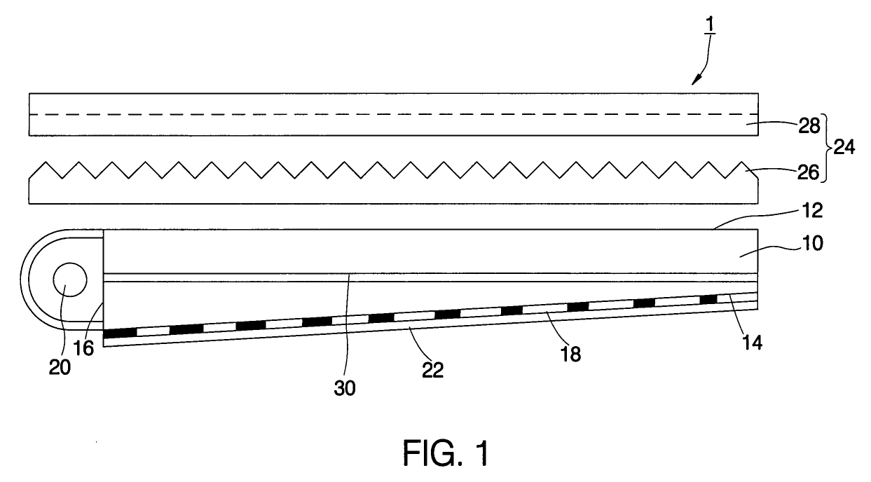

As shown in FIG. 1, a backlight unit 1 of the first preferred embodiment of the present invention comprises a light guide plate 10, a lamp 20, a reflective film 22 and a brightness enhancement member 24:

The light guide plate 10 has a first side 12, a second side 14 and a third side 16, wherein the first side 12 is opposite to the second side 14 and the third side 16 is located at between the first side 12 and the second side 14. A printed layer 18 is provided on the second side 14 of the light guide plate 10. The lamp 20 is arranged beside the third side 16 of the light guide plate 10. The reflective film 22 is attached on the printed layer 18. The brightness enhancement member 24 has two prism plates 26 and 28 arranged above the first side 12 of the light guide plate 10.

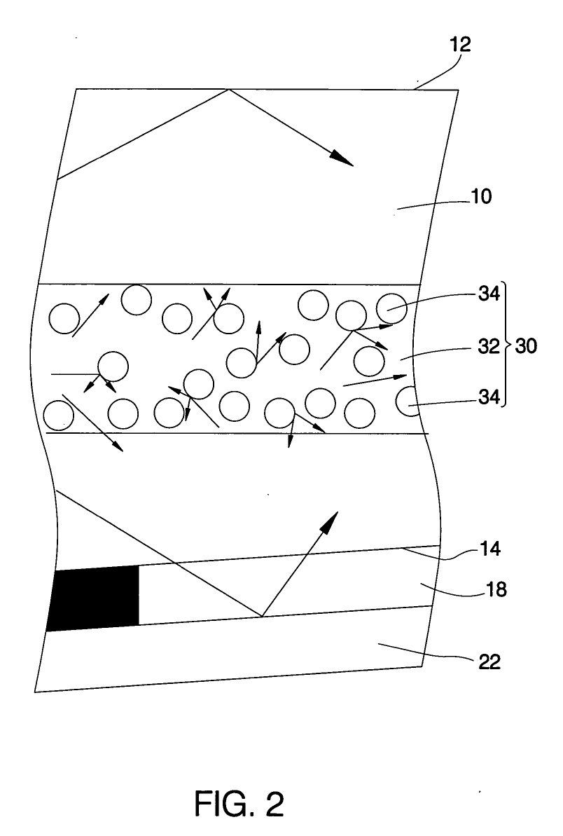

The light guide plate 10 can be made of Polycarbonate (PC), Polymethyl methacrylate (PMMA), Cyclic Olefins Polymer (COP) or Cyclic Olefins Copolymer (COC). A diffusive layer 30 is embedded in the light guide plate 10 between the first side 12 and the second side 14. A shown in FIG. 2, the diffusive layer 30 has a base 32 and a plurality of grains 34 distributed in the base 32. Injection molding and co-extrusion can be applied to fabricate the light guide plate of the present invention.

Diameters of the grains 34 in the diffusive layer 30 are preferred less than 50 μm and a thickness of the base 32 is preferred double greater than the diameters of the grains 34. In other words, the grains 34 are preferred totally embedded in the base 32, such that only the base 34 will has yellowing because of the grains 34. The base 32 of the diffusive layer 30 can be made of Polycarbonate (PC), Polymethyl methacrylate (PMMA), Cyclic Olefins Polymer (COP) or Cyclic Olefins Copolymer (COC) just like the light guide plate 10. For the mechanical property, the light guide plate 10 and the base 32 of the diffusive layer 30 are preferred made of same material to have same thermal expansion in high-temperature environment. A thermal stability agent is added into the diffusive layer 30 to decrease the yellowing of the base 32.

The diffusive layer 30 serves both functions of changing the paths of light and diffusion. As shown in FIG. 2, while the lamp 20 emits the light directly to the diffusive layer 30, the light is reflected and refracted by the grains 34 to change the paths of the light. To compare with the conventional light guide plate, there are two elements, the printed layer and the reflective film, in the conventional light guide plate for changing the paths of the light, but the present invention has three elements, the diffusive layer 30, the printed layer 18 and the reflective film 22, involved in the action of changing the paths of the light. As a result, the light guide plate 10 of the present invention has a better performance in changing the paths of the light and emitting the light out of the light guide plate 10 via the first side 12 thereof.

For diffusion, as shown in FIG. 2, the lamp 20 emits the light, shown as the arrows in FIG. 2, into the light guide plate 10. Some of the light travels to the second side 14 and is reflected by the printed layer 18 and the reflective film 22, and then the light travels to the diffusive layer 30. Some of the light travels to the first side 12 and is reflected thereat to travel to the reflective layer 30. The light traveling through the diffusive layer 30 is reflected and refracted by the grains 34 for diffusion. The light traveling through the diffusive layer 30 might travel to the first side 12 or the second side 14 and might be reflected back to the diffusive layer 30 again. As s result, most of the light generated from the lamp 20 might travel through the diffusive layer 30 several times that provides a well diffusion of the light traveling out of the light guide plate 10.

To compare with the Sue's invention, the present invention provides fewer grains in the light guide plate, which decreases the cost of the light guide plate of the present invention. The present invention also has less yellowing in the light guide plate, which the yellowing only occurred in the dissuasive layer.

In practice, the light guide plate might be embedded with two or more diffusive layers according to the optical requirement.

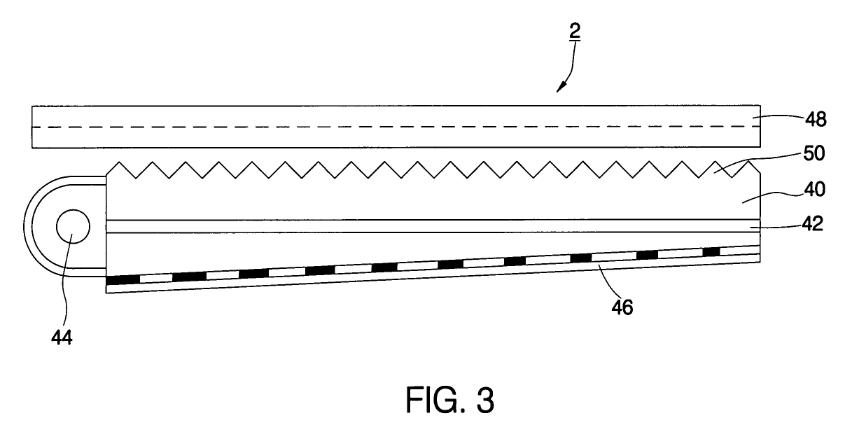

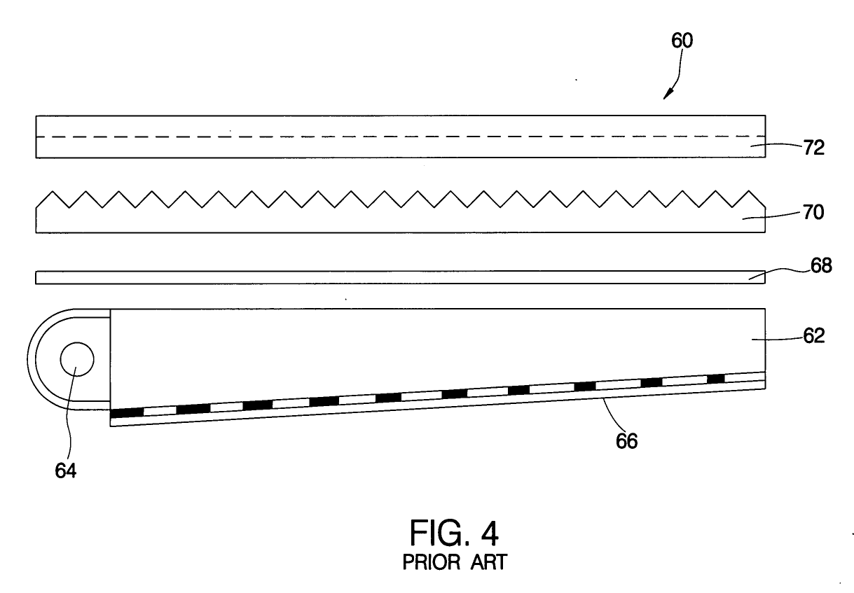

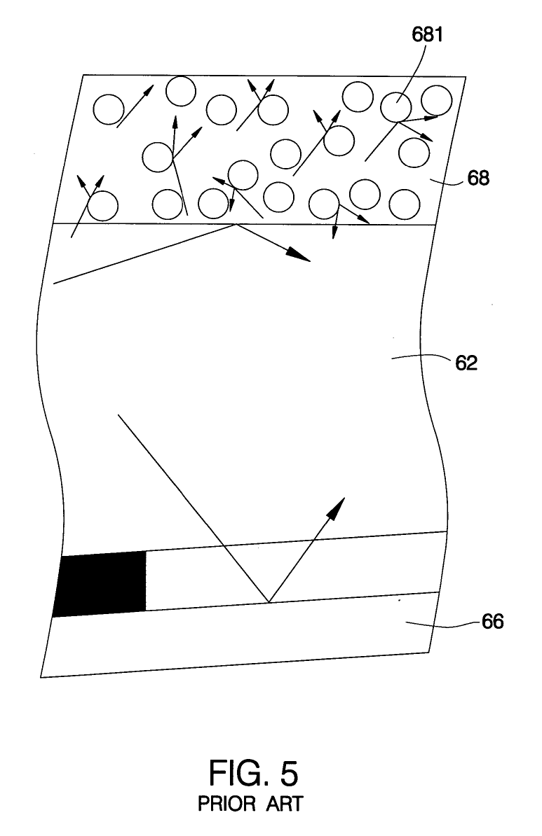

FIG. 3 shows a backlight unit 2 of the second preferred embodiment of the present invention, which has a light guide plate 40 with a diffusive layer 42 embedded therein, a lamp 44, a reflective film 46 and a brightness enhancement member 48. The brightness enhancement member 48 has a surface profile 50 on a first side of the light guide plate 40, which is a plurality of prisms on the first side, and a prism plate 48. The surface profile 50 of the light guide plate 40 and the prism plate 48 serve the function of brightness enhancement. The backlight unit 2 of the second preferred embodiment of the present invention is consisted of four elements that are fewer than that of the conventional backlight unit (six elements). A thickness of the backlight unit 2 of the second preferred embodiment of the present invention is reduced as well as the cost is reduced too.

What is claimed is:

1. A backlight unit, comprising:
a light guide plate having a diffusive layer therein, wherein the light guide plate has a first side and a second side opposite to the first side and the diffusive layer has a base and a plurality of grains in the base and is arranged between the first side and the second side of the light guide plate;
a lamp arranged beside the light plate;
a reflective film attached on the second side of the light guide plate, and a brightness enhance member provided at the first side of the light guide plate.

2. The backlight unit as defined in claim 1, wherein the base of the diffusive layer is made of a material as same as that of the light guide plate.

3. The backlight unit as defined in claim 1, wherein the brightness enhancement member has a plate with a predetermined surface profile thereon and a surface profile on the first side of the light guide plate, which the surface profiles serve a function of brightness enhancement.

4. The backlight unit as defined in claim 3, wherein the surface profile on the first side of the light guide plate has a plurality of prisms and the surface profile of the plate has a plurality of prisms.

5. A backlight unit for a liquid crystal display, comprising a light guide plate and a diffusive layer embedded in the light guide plate, wherein the light guide plate has a first side and a second side opposite to the first side and the diffusive layer has a base and a plurality of grains in the base and is arranged between the first side and the second side of the light guide plate.

6. The backlight unit as defined in claim 5, wherein the base of the diffusive layer is made of a material as same as that of the light guide plate.

7. The backlight unit as defined in claim 5, wherein the light guide plate has a predetermined surface profile on the side thereof.

8. The backlight unit as defined in claim 5, wherein the diffusive layer has a thermal stability agent in the base.
